(19) United States
(12) Patent Application Publication
(10) Pub. No.: US 2025/0371965 A1
(43) Pub. Date: Dec. 4, 2025

(54) MULTI-CARRIER CELLULAR RADIOS IN PREMISES MONITORING SYSTEMS

(71) Applicant: The ADT Security Corporation, Boca Raton, FL (US)

(72) Inventor: Charbel E. HAYEK, Boca Raton, FL (US)

(21) Appl. No.: 18/732,971

(22) Filed: Jun. 4, 2024

(51) Int. Cl. G08B 25/00; H04W 4/029

(52) U.S. Cl. CPC G08B 25/004; H04W 4/029

(57) ABSTRACT

A premises monitoring system for providing multi-carrier cellular delivery of premises monitoring services are disclosed. According to one aspect, a method in a premises monitoring system includes determining a location of the premises based on one of a global positioning system input or location information from a cellular radio base station or a handheld installer device. The method includes selecting for access to the cellular network, a first cellular service provider profile from a plurality of cellular service provider profiles stored in a multi-cellular service provider eSIM based on a signal quality indicator. The method also includes accessing cellular radio communications via a first cellular service provider corresponding to the selected first MNO profile and operating the cellular radio to transmit and receive cellular radio communications pertaining to the premises monitoring services via the first cellular service provider.

### TECHNICAL FIELD

The present disclosure is generally related to multi-carrier cellular radios in premises monitoring systems.

### BACKGROUND

Premises monitoring systems, such as home alarm systems that detect intrusions, smoke, carbon monoxide, etc., may include premises monitoring devices that may be placed at premises to monitor the premises. Communications between a remote monitoring center and the premises monitoring system may be by wireless communications or wireline communications or both.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example networked environment according to various embodiments of the present disclosure;

FIG. 2 is a block diagram of an example of several entities of the networked environment of FIG. 1 according to various embodiments of the present disclosure;

FIG. 3 is a block diagram of an example computing environment according to various embodiments of the present disclosure;

FIG. 4 is a block diagram of an example handheld installer device according to various embodiments of the present disclosure;

FIG. 5 is a block diagram of an example lookup table and location unit of various processing circuitries of FIGS. 2, 3 and 4 according to various embodiments of the present disclosure; and

FIG. 6 is a flowchart of an example process performed in a premises monitoring system according to various embodiments of the present disclosure.

### DETAILED DESCRIPTION

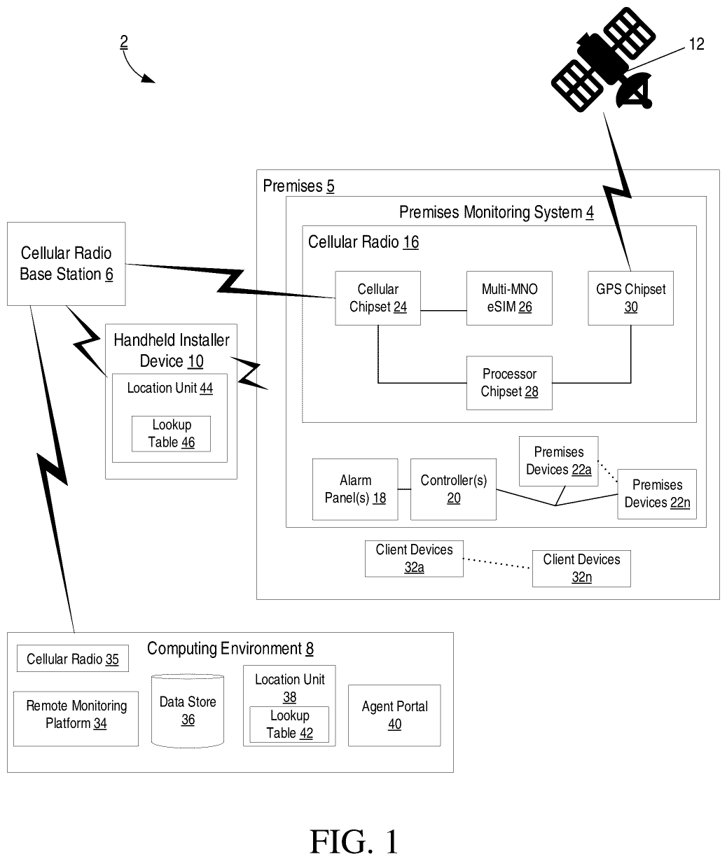

With reference to FIG. 1, shown is a block diagram of an example of a networked environment 2 according to some embodiments of the present disclosure. Networked environment 2 includes a premises monitoring system 4 associated with premises 5, at least one cellular radio base station 6, a computing environment 8, and a handheld installer device 10. The handheld installer device 10 may be a smartphone, tablet, laptop, or other handheld device that is configured to perform one or more functions described herein, for example. The networked environment 2 may also include a global positioning system (GPS) satellite 12. A cellular radio base station 6 may be configured to serve, or provide coverage to, a plurality of wireless devices within a cell or geographical area for cellular communications. As used herein, the term “location” may refer to the physical location of a premises monitoring system 4 and/or cellular radio 16 that is served by a cellular radio base station 6. A cellular radio base station 6 may be an existing cellular radio base station 6 configured to provide cellular communications with various wireless devices within the cell or geographical area associated with the cellular radio base station 6. The cellular radio base station 6 may serve the premises monitoring system 4 and/or cellular radio 16 by providing cellular radio communications to these entities.

The premises monitoring system 4 includes a cellular radio 16, an alarm panel 18 and at least one controller 20 to control premises devices 22a-22n (hereinafter referred to collectively as premises devices 22). In some embodiments, the cellular radio 16 may be (i) a component of the controller 20 or (ii) a separate device that communicates with the controller 20. In some embodiments, functions of the controller 20 and the alarm panel 18 may be combined in a single device.

The cellular radio 16 includes a cellular chipset 24 that is configurable to perform cellular communications with the cellular radio base station 6, one or more mobile network operators (MNO), an embedded subscriber identity module (eSIM) 26 and a processor chipset 28. The cellular chipset 24 may be configured to be compliant with Third Generation Partnership Project (3GPP) standards such as, for example, Long Term Evolution (LTE) standards, Fifth Generation (5G) standards, etc. The multi-MNO eSIM 26 may be configured to store MNO-specific data, including authorization data, for each of a plurality of MNOs, also referred to herein as cellular service providers. The authorization data for a cellular service provider may be stored in a cellular service provider profile. The cellular service provider profile may include a cellular subscriber authorization number associated with the cellular service provider, where the cellular device (e.g., cellular radio 16) that includes the multi-MNO eSIM 26 is authorized to utilize that cellular service provider's cellular services. A cellular service provider profile may also include information about a cellular service plan associated with the cellular service provider, such as available minutes and available data, as well as allocation of these resources to voice, video and data.

One or more cellular subscribers may subscribe to a cellular communication service provided by a cellular communication service provider. In some embodiments, the cellular subscriber is a premises monitoring services provider that may subscribe to the cellular communication services of multiple different cellular service providers in different cells or areas of service provided by the different cellular service providers. Such cellular communication services may include, telephone, video, Internet connectivity, data, texting and email. In one or more embodiments, a premises monitoring services provider, such as a company that provides remote monitoring of multiple premises monitoring system 4 for customers in multiple geographic regions, may have pre-arranged agreements with a plurality of cellular service providers such that cellular radio 16 is serviceable by one or more of the plurality of cellular service providers. In some embodiments, a premises monitoring system 4 may receive and transmit premise monitoring-related data over the cellular network as enabled by the cellular service provider. A cellular service provider to which a premises monitoring services provider is subscribed may be referred to herein as a “subscribed cellular service provider.”

The cellular radio 16 may also include a GPS chipset 30 in communication with the GPS satellite 12. In some embodiments, the cellular radio 16 may be separate from the premises monitoring system 4, but located at the premises 5. For example, the cellular radio 16 may be located within the premises and be in wireless communication with the premises monitoring system 4 via one or more networks, such as, for example, a local area network (e.g., wireless local area network (WLAN), Wi-Fi, etc.) at premises and/or short range wireless protocol network (e.g., BLUETOOTH LOW ENERGY (BLE), ultra-wideband (UWB), ZIGBEE, Z-WAVE, among other Institute of Electrical and Electronics Engineers (IEEE) based short range wireless protocols, etc.). In some embodiments, the cellular radio 16 may include a Wi-Fi Access Point (SP) station (STA) and controllers 20 may include a Wi-Fi non-AP STA, compliant with IEEE 802.11 standards.

An alarm panel 18 may be, or include, a wall-mountable panel device (e.g., a wall-mounted alarm system panel), a tabletop panel device (e.g., a tabletop alarm system panel), an alarm control panel having an enclosure and hinged door configured to be mounted in a closet, etc. The alarm panel 18 may include a user interface, such as a display and keyboard, that enables an occupant of the premises 5 to control the operational status of the premises monitoring system 4. A controller 20 may be located with or separate from the alarm panel 18 and may be configured to control and/or monitor one or more premises devices 22, such as electronic locks, doors, windows, actuators, valves, motors, and any other controllable devices associated with premises monitoring system 4. An alarm panel 18 and/or controller 20 may be in communication with one or more premises devices 22 (e.g., lights, cameras, microphones and speakers) that enable the premises monitoring system 4 to monitor the premises 5, and that also enable a premises occupant to visualize and/or hear one or more alarms. The alarms associated with premises devices 22 may be activated and deactivated at an alarm panel 18 or at the computing environment 8 or at the handheld installer device 10, in some embodiments. Functions of the controller 20 and the alarm panel 18 may be combined in a single device.

Premise device 22 may include one or more sensors, devices configured to capture audio, images, and/or video, and/or other devices. For example, premises devices 22 may include motion sensors, fire sensors, smoke sensors, heat sensors, carbon monoxide sensors, flood sensors, flow sensors, temperature sensors, humidity sensors, proximity sensors, contact sensors, glass break sensors, water consumption sensors, water pressure sensors, etc. Devices configured to capture audio, images, and/or video may be referred to as multimedia devices and may include digital cameras, video cameras, microphones, etc. Additional examples of premises devices 22 include sirens, garage door controllers, smart doorbells (e.g., video doorbell camera configured to capture audio, images and/or video), temperature sensors, humidity sensors, lighting devices, switches, electrical outlets, electronic locks, electronic door locks with a microphone and a visual indicator, and electrical plugs. Premises device 22 may also include lights and a controller 20 may also provide lighting control via an alarm panel 18.

The premises 5 may also include client devices 32a-32n (hereinafter referred to collectively as client devices 32). Client devices 32 may include wireless devices, such as mobile phones, computers, smart devices, game devices and televisions, for example. In some embodiments, at least one client device 32 is in communication with the cellular radio base station 6 via the cellular radio 16 and the cellular chipset 24.

In one or more embodiments, a controller 20 and/or alarm panel 18 is configured to generate and transmit status reports to the computing environment 8 and/or the handheld installer device 10. A controller 20 and premises devices 22 may communicate with each other using various protocols and network topologies. These include wired and wireless topologies. For example, the controller 20 and premises devices 22 may wirelessly communicate using communications compliant with one or more versions of the Z-WAVE protocol, ZIGBEE protocol, WI-FI protocol, THREAD protocol, BLUETOOTH protocol, Digital Enhanced Cordless Telecommunications (DECT) protocol, and/or other protocols.

The cellular radio base station 6 may be an eNodeB (eNB) or gNodeB (gNB) in an LTE and/or 5G cellular radio communication system. The cellular radio base station 6 may be in wired or wireless communication with the computing environment 8, to facilitate monitoring of premises monitoring systems 4 at the computing environment 8 via of at least one cellular radio base station 6.

Thus, a cellular radio base station 6 is configured to communicate with a plurality of entities, including the premises monitoring system 4 via the cellular radio 16. The cellular chipset 24 within the cellular radio 16 may include circuitry, described herein, to transmit and receive cellular signals to and from the cellular radio base station 6. In some embodiments, there are multiple cellular radio base stations 6 capable of communication with the premises monitoring system 4 via cellular radio 16.

As mentioned above, in some embodiments, one or more cellular service providers may provide cellular communication services to one or more devices, according to an agreement between a premises monitoring services provider and one or more cellular service providers. For example, a premises monitoring services provider may provide premises monitoring services to premises 5 according to one or more agreements with one or more cellular service providers that provide cellular service to the location of a premises 5. Thus, the premises monitoring services provider may have agreements in place to use cellular communication services provided by one or more cellular service providers via at least one cellular radio base station 6 in the vicinity of the cellular radio 16.

In some embodiments, the operational state of the premises monitoring system 4 may be controlled and/or monitored remotely at the computing environment 8 (via cellular radio base station 6) and/or via the handheld installer device 10. For example, the premises monitoring system 4 may be controlled according to instructions received from the computing environment 8 via cellular radio base station 6 and/or received from the handheld installer device 10. The computing environment 8 and/or the handheld installer device 10 may be configured to monitor an operational status of the premises monitoring system 4. For example, the computing environment 8 is configured to receive, via the cellular radio base station 6, indications of alarm and/or operational status of the premises monitoring system 4 as a whole, and/or any subsystem thereof. The handheld installer device 10 may include a location unit 44 that determines one or more available cellular service providers based at least in part on the location of the premises 5. For example, the location unit 44 may include a lookup table that maps a location of the cellular radio 16 to a preferred cellular service provider among a plurality of cellular service providers. The preferred cellular service provider may be selected based at least in part on pre-obtained knowledge of quality of service (QOS) deliverable to the location of the cellular radio 16 by one or more of the plurality of cellular service providers.

The computing environment 8 may include one or more computing systems used by the provider of premises monitoring services (i.e., the premises monitoring services provider). The handheld installer device 10 may be used by a technician (e.g., an installation or service technician) when installing or servicing components at the premises 5. The handheld installer device 10 may be used by the technician to configure, test, and control aspects of the premises monitoring system 4. For example, the handheld installer device 10 and/or the computing environment 8 may be used to specify a primary cellular service provider and/or a secondary cellular service provider and/or a default cellular service provider to be used for cellular communications between a cellular radio base station 6 and the premises monitoring system 4. In some embodiments, for example, a premises monitoring services provider may dispatch a technician to the premises 5 and to perform an initial configuration of the cellular radio 16 via the handheld installer device 10. The initial configuration may specify a preferred cellular service provider to be used by the cellular radio 16 until a subsequent configuration is implemented (for example, when channel conditions or cellular radio base station configurations change). In some embodiments, the initial configuration and/or a subsequent configuration may be selected remotely by components of the computing environment 8 or the handheld installer device 10 and communicated to the cellular radio 16 to configure the cellular radio 16 to use the initial or subsequent configuration.

A plurality of premises monitoring systems 4 may be configured to communicate with components of the computing environment 8 via one or more cellular networks, such as LTE and 5G networks. In addition to cellular networks, the premises monitoring system 4 may be in communication with components of the computing environment 8 and/or the handheld installer device 10 via other communication networks. These may include, for example, one or more intranets, extranets, a wireless local area network (WLAN), a wide area network (WANs), LANs, wired networks, wireless networks, cellular networks, satellite networks, Data Over Cable Service Interface Specification (DOCSIS) networks, Plain Old Telephone Service (POTS) networks, and/or other types of networks.

The computing environment 8 may include a remote monitoring platform 34, data store 36, location unit 38 and agent portal 40. The remote monitoring platform 34 may be configured to operate with a cellular radio 35 configured to communicate with the cellular radio base station 6. The remote monitoring platform 34 may receive, via the cellular radio 35, indications of the alarm status and/or other operational status of the premises monitoring system 4, its alarm panel(s) 18, controller(s) 20 and/or premises devices 22. These indications may include indications of a state or condition (such as an off-or-on state or an alarm state) of one or more premises devices 22. Data store 36 may be configured to store data associated with one or more premises monitoring systems 4, one or more cellular service providers, etc. Data store 36 may be a database. Data store 36 may be a secure data store that is configured for at least temporary store of data for retrieval, management and/or analysis. For example, the data store 36 may store one or more of status reports, physical address information for various premises monitoring systems 4, etc.

In some embodiments, a premises monitoring services subscriber may be subscribed with a premises monitoring services provider, and the premises monitoring services provider may subscribe to one or more cellular service providers providing cellular radio communications to the premises 5. The multiple cellular service providers may provide cellular communication with the premises monitoring system 4 via the same cellular radio base station 6 or via different cellular radio base stations 6. The quality of service (QOS) provided by one cellular service provider in a location may be better, (e.g., in terms of throughput, received signal strength and latency), than the QoS provided by a different cellular service provider in the same location. This may be due to one or more factors, which may include, for example: changes in the antennas and radios at the cellular radio base station(s) 6 that serve the location, and changes in the channel between the cellular radio base station(s) 6 and the premises 5, line of sight, etc.

As used herein, the term “signal quality” may refer to a signal strength measurement or a signal quality determination that may be based at least in part on the power of a received cellular signal. Examples of signal quality may include one or more of received signal power, received signal quality, reference signal received power (RSRP), reference signal received quality (RSRQ), signal to interference plus noise ratio (SINR) and signal to noise ratio (SNR), for example. Signal quality may be used as a measure of throughput and latency. The term “signal quality indicator” may refer to a value used to indicate signal quality, such as a relative numerical value that indicates a signal quality relative to a reference signal quality.

Thus, at any given time, a first premises monitoring system 4 in a first location may receive a signal having the highest signal quality from a first cellular service provider and a second premises monitoring system 4 in second location may receive a signal having the highest signal quality from a second cellular service provider. At a subsequent time, the cellular service provider providing a signal having the highest quality to the first premises monitoring system 4 may be the second cellular service provider or yet a third cellular service provider. Accordingly, a cellular service provider providing a best signal quality for the location of the premises monitoring system 4 or cellular radio 16 may be selected for network access by cellular radio 16. In one or more embodiments, network access may refer to initial network access by which cellular radio 16 initially establishes a connection with a cellular service provider via cellular radio base station 6 such as, for example, during installation of cellular radio 16 or re-installation of cellular radio 16 at another premises 5. In one or more embodiments, network access by cellular radio 16 may refer to establishing or re-establishing a connection with a current cellular service provider or another cellular service provider after initial network access.

The selected cellular service provider may be updated periodically and/or in response to an input or a trigger from the computing environment 8 and/or the handheld installer device 10. In some embodiments, the handheld installer device 10 and/or the computing environment 8 and/or the cellular radio 16 may select the cellular service provider from among the cellular service providers that deliver the best quality signal to the premises 5 or premises monitoring system 4. The selected cellular service provider may then be used by the cellular radio 16 to receive communications, until such time as a different cellular service provider is selected.

In some embodiments, the selection of cellular service providers may be performed by the location unit 38. For example, a primary cellular service provider and/or a secondary cellular service provider and/or a default cellular service provider may be selected based at least in part on the location of the premise monitoring system 4 and/or cellular radio 16. The primary cellular service provider may be the cellular service provider that delivers the highest signal quality to the cellular radio 16 when compared to at least one other cellular service provider. A secondary cellular service provider may be the cellular service provider that delivers the second highest signal quality. Thus, the cellular service providers may be ranked in order of signal quality indicator. This ranking may be updated periodically or in response to a trigger or input by an agent of the premise monitoring service. The selection of primary, secondary and/or default cellular service providers may be changed from time to time. Once a selection of a cellular service provider is made, the agent via the agent portal 40 may cause the cellular radio 16 to configure for use of the selected cellular service provider. Configuring the cellular radio 16 for use of a selected cellular service provider includes configuring the cellular radio 16 to communicate on time-frequency resources assigned to the selected cellular service provider for the location of the premises 5.

Data representing cellular service provider selection(s) and rankings may be stored in the data store 36 and/or in a memory of the premises monitoring system 4 and/or in a memory of the handheld installer device 10. The cellular service provider selection(s) and rankings may be made at the cellular radio 16 after measuring a signal quality of a signal from each subscribed cellular service provider. The signal quality may be measured by the cellular chipset 24. Examples of signal quality measurements may include signal to noise ratio (SNR), signal to interference plus noise ratio (SINR), reference signal received power (RSRP) and/or reference signal receive quality (RSRQ). Each signal quality measurement may be mapped to a corresponding signal quality indicator.

The selection of one or more cellular service providers by the location unit 38 may be based at least in part on queries of a look up table 42 made by an agent of the premises monitoring services provider using the agent portal 40. An agent may use a computing device, such as workstation that includes a keyboard, mouse and video monitor, to use the agent portal 40 to interactively control the location unit 38 and/or the contents of the lookup table 42 and/or the operational status of a premise monitoring system 4. The lookup table 42 may include a mapping between locations and cellular service providers. Each location may be associated with one or more cellular service providers serving the location. Each premises monitoring system may be associated with a location and be associated with one or more cellular service providers serving the location. Each location may be associated with a signal quality indicator associated with each cellular service provider serving that location. The associations between locations, premises, premises monitoring systems, cellular service providers and signal quality indicators may be stored as one or more lookup tables 42 in the data store 36.

In some embodiments, the handheld installer device 10 may include a location unit 44 with a lookup table 46. The location unit 44 may be configured to select a preferred cellular service provider (one with the highest signal quality, for example) and rank a set of cellular service providers according to the quality of the signals they deliver to the premises 5, premises monitoring system 4, and/or cellular radio 16. When there is only one cellular service provider serving a location, one cellular service provider may be activated by default. Also, a default cellular service provider may be a cellular service provider that is selected in an event that continued use of a primary cellular service provider is disrupted. Once the selection of a cellular service provider is made, a technician via the handheld installer device 10, may cause the cellular radio 16 to be configured for use of the selected cellular service provider. Configuring the cellular radio 16 for use of a selected cellular service provider includes configuring the cellular radio 16 to communicate on time-frequency resources assigned to the selected cellular service provider for the location of the premises monitoring system 4.

The selected one or more cellular service providers for the location of the premises monitoring system 4 may be selected from among a plurality of cellular service providers. This selection may be made based at least in part on subscriber authorization data stored in the multi-MNO eSIM 26. The multi-MNO eSIM 26 may obtain the subscriber authorization data from the premises monitoring services provider, for example, or may be obtained from one or more cellular service providers that have an agreement to provide cellular communications pertaining to premises monitoring services provided to the premises 5 by the premises monitoring services provider.

Once a location of the premises 5 is known, a cellular service provider expected to provide best coverage of that location, (e.g., in terms of highest throughput, lowest latency and/or highest received signal strength), may be selected from the lookup table 42, 46 (i.e., retrieved from memory) as the preferred cellular service provider for the premises 5. The selection of cellular service provider to serve the premises 5 may be made at the computing environment 8, via the handheld installer device 10 or autonomously by the cellular radio 16. Once the preferred cellular service provider is selected, its signal quality may be measured to verify that an adequate signal quality for the selected cellular service provider can be received. This verification may be made by comparing a measured signal quality to a threshold. When the signal quality is above the threshold, the selected cellular service provider may be activated, provided that the selected cellular service provider is a subscribed cellular service provider. Activating the selected cellular service provider may include configuring the cellular radio 16 to operate on cellular network resources assigned to the selected cellular service provider. The threshold to which a signal quality is compared may be stored in a memory of the handheld installer device 10 or in a memory of the premises monitoring system 4.

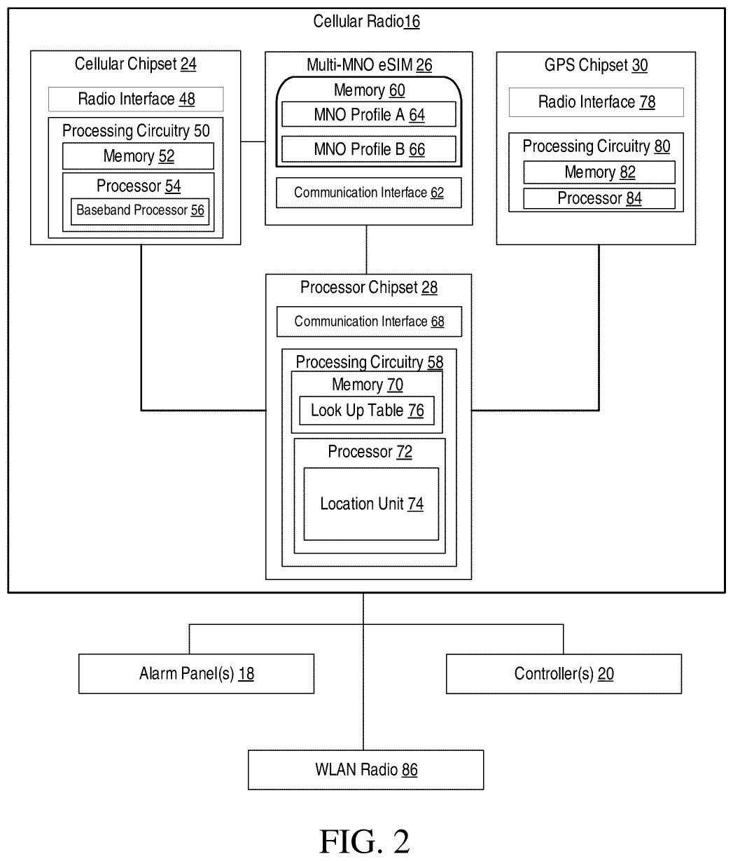

Referring to FIG. 2, the cellular radio 16 is shown in more detail. In some embodiments, the cellular radio 16 includes the cellular chipset 24, the multi-MNO eSIM 26, the processor chipset 28, and the GPS chipset 30. The cellular chipset 24 includes a radio interface 48 in communication with processing circuitry 50. The processing circuitry 50 may include memory 52 and processor 54, the processor 54 being configured to execute computer instructions stored in the memory 52. The cellular chipset 24 may be an, for example, LTE and/or 5G cellular chipset that is configured to receive, transmit and process LTE and/or 5G signals. For example, the radio interface 48 may include an array of antennas and an RF front end that includes a radio transmitter and a radio receiver. The processor 54 of the processing circuitry 50 may include a baseband processor 56 configured to perform modulation and coding of signals to be transmitted, and demodulation and decoding of signals that are received, in accordance with 3GPP standards for LTE and/or 5G signals.

The processor 54 may be configured to select time and frequency resources corresponding to each of a plurality of cellular service providers and to configure the radio interface 48 to receive and transmit data using those resources. For example, different time slots for communication may be allocated to different cellular service providers. Also, different cellular service providers may operate in different frequency bandwidth parts (BWP) and different cellular service providers may operate on different frequency subcarriers. For example, a first cellular service provider may utilize first subcarrier frequencies in a first BWP and a second cellular service provider may utilize second subcarrier frequencies in a second BWP. The cellular radio 16 may be configured to process first signals on first time and frequency resources allocated to a first cellular service provider and to process second signals on second time and frequency resources allocated to a second cellular device, simultaneously on different frequencies, and/or alternately in time.

In some embodiments, the processing circuitry 50 of the cellular chipset 24 or processing circuitry 58 of the processor chipset 28, is only able to successfully decode and extract information from signals that correspond to a particular cellular service provider. This ability may be activated or deactivated for a cellular service provider by the processing circuitry 50 and/or processing circuitry 58 based at least in part on information that includes cellular service provider-specific subscriber authorization data (hereinafter referred to as authorization data), from the multi-MNO eSIM 26. An authorized cellular service provider service may be activated by enabling the processing circuitry 50 of the cellular chipset 24 or processing circuitry 58 of the processor chipset 28 to decode and otherwise process signals of the cellular service provider providing the authorized cellular service provider service.

The multi-MNO eSIM 26 has a memory 60 and a communication interface 62. The memory 60 may include multiple cellular service provider profiles, such as service provider A profile 64 and service provider B profile 66. Each cellular service provider profile 64, 66 stored in the multi-MNO eSIM 26 may include authorization data for each cellular service provider of a plurality of cellular service providers. A cellular service provider profile 64, 66 for a particular cellular service provider may include authorization data that identifies to the corresponding cellular service provider that the cellular device which includes the multi-MNO eSIM 26 is authorized to utilize that cellular service provider's cellular services. A cellular service provider profile 64, 66 may also include cellular service provider-specific information about a cellular subscriber's plan, such as available minutes and available data, as well as allocation of available minutes and data to voice, data and text, for example.

The communication interface 62 of the multi-MNO eSIM 26 is configured to provide read and write access to the contents of the memory 60. For example, in some embodiments, the communication interface 62 may be configured to only allow writing to and reading from the cellular service provider profile A 64 upon applying a certain address or code to input pins of the communication interface 62, the address or code being known only by the cellular service provider A. In some embodiments, the communication interface 62 may be polled by the cellular chipset 24 and/or the processor chipset 28 to determine whether any particular one or more of a plurality of cellular service providers is activated or authorized. For example, the cellular service provider profile A 64 may include a first subscriber authorization code A that authorizes use of the services of cellular service provider A 64, and the cellular service provider profile B 66 may include a second subscriber authorization code B that authorizes use of the services of cellular service provider B. Which cellular service provider's services are authorized may be indicated by presence or absence of a subscriber authorization code corresponding to the cellular service provider. A cellular service provider may then be selected from among the authorized cellular service providers.

The processor chipset 28 includes a communication interface 68, and the processing circuitry 58, mentioned above. The processing circuitry 58 may include memory 70 and a processor 72. The processor 72 may be configured to implement a location unit 74. The memory 70 may include a look up table 76 configured to store a mapping between cellular service providers and locations as described above with respect to look up tables 42 and 46. A location unit 74 of the processor 72 may operate as described above with respect to location units 38 and 44. For example, the location unit 74 may be configured to select one or more cellular service providers among a plurality of subscribed cellular service providers, as may be determined by one or more queries of the multi-MNO eSIM 26, and based at least in part on whether a signal quality of an authorized cellular service provider is better than the signal quality of other authorized cellular service providers and/or based at least in part on whether a signal quality indicator corresponding to the cellular service provider exceeds a signal quality threshold.

A mapping between cellular service providers and premise locations stored in one or more of the lookup tables 42, 46 and 76, may be based at least in part on previously obtained QoS information. For example, after a reconfiguration of one or more of cellular radio base stations 6, the cellular radios 16 of each of at least one premises 5, may sequentially measure the signal quality from each of the plurality of subscribed cellular service providers. In some embodiments, the signal quality of unsubscribed cellular service providers delivering cellular communication service to a location may also be measured by the cellular chipset 24 of the cellular radio 16. The signal quality measurements may be mapped to signal quality indicators for the subscribed cellular service providers and optionally, the unsubscribed cellular service providers, and stored in a lookup table 42, 46 and 76.

The location of the premises 5, premises monitoring system 4 and/or cellular radio 16 may be known or ascertained from the GPS chipset 30. Alternatively or in addition, the location of the premises 5, premises monitoring system 4 and/or cellular radio 16 may be based at least in part on knowledge of the location of a physical address of the premises 5. Alternatively or in addition, the location of the premises 5 may be determined by a GPS chipset (not shown) located in the location unit 44 of the handheld installer device 10, when the handheld installer device 10 is brought to the location of the premises 5. Alternatively or in addition, the location of the premises 5 may be determined based at least in part on location information from the cellular radio base station 6.

The GPS chipset 30 includes a radio interface 78 and processing circuitry 80. The processing circuitry 80 may include memory 82 and a processor 84. The GPS chipset 30 may be any GPS chipset capable of ascertaining its location based at least in part on information from GPS satellite signals. The GPS chipset 30, when present, is configured to provide location or position information to the processor chipset 28.

The premises monitoring system 4 may also include a wireless local area network (WLAN) radio 86 that is configured to be compliant with an IEEE 802.11 standard for WLAN communications, such as Wi-Fi. The WLAN radio 86 may be configured to communicate with the handheld installer device 10 when the handheld installer device 10 is at the premises 5 and may be configured to communicate with the processor chipset 28 and/or the multi-MNO eSIM 26. The handheld installer device 10 is configured to enable an on-site agent, such as a technician, to configure the cellular radio 16 via a WLAN connection with the WLAN radio 86.

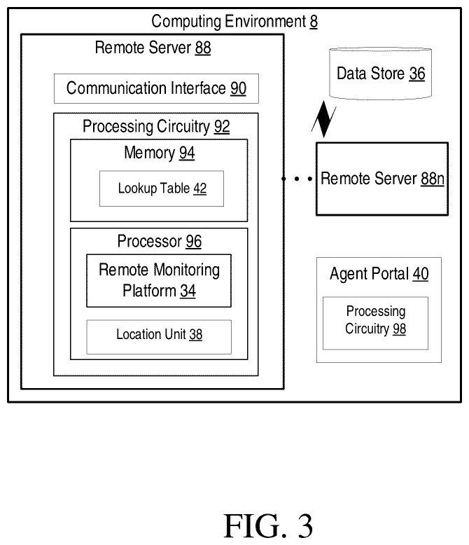

FIG. 3 is a block diagram of an example computing environment 8. The computing environment 8 may include a plurality of remote servers 88, . . . 88n. A remote server 88 includes a communication interface 90 and processing circuitry 92. The communication interface 90 may be configured to communicate wirelessly via the cellular radio base station 6 with each of a plurality of premises 5 and premises monitoring systems 4. The computing environment 8 may also provide an agent portal 40, such as an online portal accessible via a web browser opening on a computing device, that is configured to facilitate monitoring agents associated with the computing environment 8 initiating and/or performing one or more monitoring actions. For example, in the event that the remote monitoring platform 34 receives status reports from a premises monitoring system 4 that indicates that an outage or alarm state has occurred, the agent portal 40 may render for display various information associated with the outage or alarm state.

The processing circuitry 92 of the remote server 88 may include memory 94 and a processor 96. The memory 94 may be configured to store the above-described lookup table 42. The processor 96 may be configured to implement the remote monitoring platform 34 and the location unit 38, as described above. Each of the plurality of remote servers 88 may be configured to access data store 36. The remote servers 88 may be located in one location, such as at the premises monitoring services provider, or may be distributed throughout a plurality of locations. Similarly, data store 36 may be shared among a plurality of the remote servers 88 or each one of the remote servers 88 may have its own local data store 36, for example.

Agent portal 40 enables agents of the premises monitoring services provider to access information about multiple premises 5 and to enable an agent to alter the operational status of any one or more of the premise monitoring systems 4. In some embodiments, the memory 94 is configured to store a plurality of lookup tables. For example, the memory 94, which may be read or written by the processor 96, may be configured to store a single lookup table 42 containing location-service provider associations for a plurality of cellular service providers and locations and the agent portal 40 may enable the agent to select a preferred, primary, secondary or default cellular service provider from an entry in the lookup table 42 corresponding to a location of any one or more premise monitoring service subscribers in the location. The selection of a subscribed cellular service provider among a plurality of cellular service providers associated with a location, as may be determined by the remote monitoring platform 34, may be performed by the premises monitoring system 4 at the location. In some embodiments, there may be one lookup table for a plurality of geographical areas that encompass multiple locations. Also, a plurality of premises service subscribers may be grouped together according to a cell or location of the premises monitoring systems 4.

Information about each premises 5 and premise monitoring system 4 stored in data store 36 may include location data, such as GPS location data and/or physical address data, for each premise 4. The information may also include a signal quality indicator for each cellular service provider serving a location of the premises 5, including a subset of such indicators for each subscribed cellular service provider serving the location of the premises 5. The remote monitoring platform 34 may be configured to analyze the signal quality indicators to, for example, determine distributions of signal level per carrier per location and to create a map of these distributions that may be visualized on a video monitor of the agent portal 40. Information about the distribution of signal levels per carrier and per location may also be presented visually in the form of tables, charts and graphs via the agent portal 40.

In some embodiments, the agent, via the agent portal 40, may monitor, control and communicate with the premises monitoring system 4 including any one or more of the alarm panels 18, the controllers 20 and the premises devices 22. For example, the agent portal 40 may enable the agent to determine whether the premises monitoring system 4 is in an alarm state and to determine which premises device(s) 22 have detected an alarm condition, and the nature of the alarm condition. The agent portal 40 may also enable the agent to deactivate (or activate) an alarm at the premises 5. The state of the premises device(s) 22 and other premise services related information may be communicated via the cellular radio base station on time-frequency resources assigned to a cellular service provider.

The agent portal 40 may also enable the agent to activate one or more cellular service providers at the premises 5, to configure the cellular radio 16 to operate using a cellular service provider. Thus, an agent, via agent portal 40, may configure a remote server 88 of the computing environment 8 to receive information concerning an operational status of a premises monitoring system 4 and to transmit information to control the operational status of the premises monitoring system 4. The agent portal 40 may also be used by the agent to download to the premise monitoring system 4, an electronic copy of a lookup table 42 that includes a mapping between locations of cellular service providers and/or signal quality indicators for the cellular service providers.

The above-described processes of receiving information about premises monitoring systems 4 and transmitting data and control signaling to control an operational state of the premises monitoring systems 4, may be provided by the processing circuitry 92 of any one or more of the remote servers 88. Alternatively, or in addition, the processes of receiving information about premises monitoring systems 4 and transmitting data and control signaling to control an operational state of the premises monitoring systems 4, may be performed by processing circuitry 98 via at least one remote server 88. In some embodiments, at least one remote server 88 may include the functionality of an agent portal 40 described herein. In some embodiments, the agent portal 40 may be used to select, via the processing circuitry 98 and/or the processing circuitry 92, which of the plurality of remote servers 88 to use to communicate with a particular premises monitoring system 4.

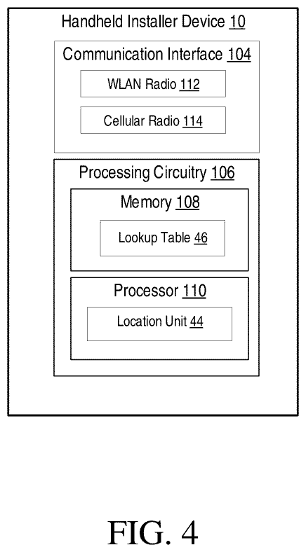

FIG. 4 is a block diagram of an example of the handheld installer device 10. The handheld installer device 10 may have less than all the functionality of a remote server 88 that is otherwise available to an agent via an agent portal 40, in some embodiments. The handheld installer device 10 may be in cellular communication with a radio of the premises monitoring system 4, the radio being one of the cellular radio 16 or the WLAN radio 86 of the premises monitoring system 4. Thus, an on-site agent may bring to the site a handheld installer device 10 and establish a wireless local area connection with the WLAN radio 86 of the premises monitoring system 4.

The handheld installer device 10 is configured to include a communication interface 104 and processing circuitry 106. The processing circuitry 106 may include memory 108 and a processor 110. The memory 108 may include the lookup table 46 and the processor 110 may implement the location unit 44. The communication interface 104 may be a wireless interface that includes a WLAN radio 112 configured to communicate with the WLAN radio 86 of the premises monitoring system 4. The communication interface 104 may also include a cellular radio 114 that is configured to communicate with the cellular radio 16 of the premises monitoring system 4 and/or communicate via a nearest cellular radio base station 6 with the computing environment 8.

In some embodiments, the handheld installer device 10 may be a portable device that may be carried by a technician associated with the premises monitoring services provider. Handheld installer device 10 may include a touch sensitive display, for example, to enable the on-site agent to visualize information and interact with the processor chipset 28 of the premises monitoring system 4. The on-site agent may interact with the processor chipset 28 to cause the processor chipset 28 to select a particular one of the plurality of subscribed cellular service providers of the premises 5. More particularly, the processing circuitry 106 may be configured to query the processor chipset 28 to determine, based at least in part on one or more cellular service provider profiles 64, 66 stored in the memory 60 of the multi-MNO eSIM 26, whether a particular cellular service provider is usable at the location. The processing circuitry 106 may also be configured to select a preferred service provider for the premises monitoring system 4. A preferred service provider may be a cellular service provider having a highest signal quality indicator for the location of the premises 5.

Indications of the available subscribed cellular service providers (those cellular service providers for which authorization data is included in the memory 60) may be retrieved by the handheld installer device 10 and displayed to the technician. Subscribed cellular service providers may be displayed including a table of relative signal quality indications for each of the subscribed cellular service providers for the location of the premises 5. The location of the premises 5 may be determined by the GPS chipset 30 (or otherwise determined) and communicated to the handheld installer device 10 via the WLAN radio 112 or the cellular radio 114. Alternatively, or in addition, the location of the premises 5 may be selected or entered by the on-site agent via the handheld installer device 10 and communicated wirelessly to the processor chipset 28.

In some embodiments, the handheld installer device 10 may configure the cellular radio 16 to measure a signal quality of signals provided by at least one cellular service provider. The measurements of signal quality may be performed periodically by the cellular radio 16 or in response to a trigger from the computing environment 8 and/or the handheld installer device 10.

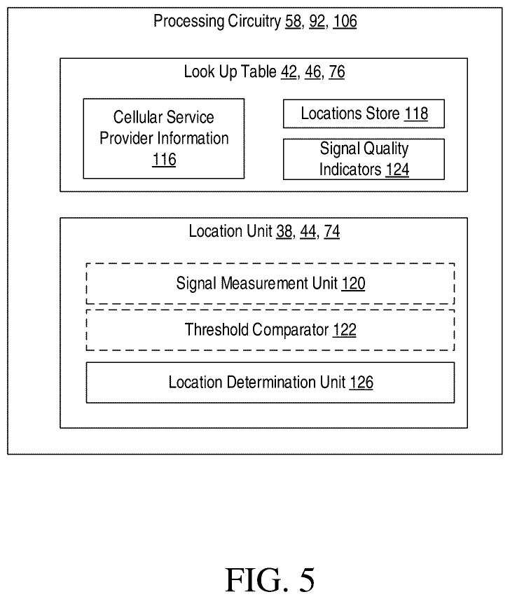

A more detailed view of an example of a lookup table 42, 46, 76 and an example of a respective location unit 38, 44, 74, within respective processing circuitry 92, 106, 58, is shown in FIG. 5. Premises-specific data may be stored in the lookup table 42, 46, 76. The premises specific data may include the signal quality measurements for each cellular service provider measured at a premises 5. Premises specific data stored in a lookup table 42, 46, 76 may include cellular service provider information 116 for cellular service providers having signal qualities that exceed the signal quality threshold. The cellular service provider information 116 may include a list of cellular service providers. The list may be in order of decreasing signal quality indicator, or in the order of increasing signal quality indicator, for example. Each cellular service provider in the list may be identified by a unique identification number.

In some embodiments, each cellular service provider may be associated with one or more locations, or each of a plurality of locations may be associated with one or more cellular service providers. These locations may be stored in the lookup table 42, 46, 76 in a locations store 118. Thus, the lookup table 42, 46, 76 may include a list of cellular service provider identifiers to identify at least one cellular service provider whose signal quality exceeds a signal quality threshold. In the processing circuitry 58 of the processor chipset 28 of the cellular radio 16, there may be configured a signal measurement unit 120 and a threshold comparator 122. The signal measurement unit 120 is configured to measure signal quality and the threshold comparator 122 is configured to compare signal quality measurements to a threshold. In some embodiments, signal quality indicators 124 may be stored in any one or more of the lookup tables 42, 46, 76. One or more of lookup tables 42, 46, 76 table that includes signal quality indicators 124 may also include an indication of whether a signal quality indicator 124 exceeds a signal quality threshold. The location determination unit 126 may determine a preferred cellular service provider (e.g., the cellular service provider providing the highest signal quality) for the premises location.

The location determination unit 126 may receive location data from the computing environment 8 and/or the handheld installer device 10. A location determination unit 126 may be located in the processor chipset 28 of the cellular radio 16 and may receive location data in location store 118 representing its location via the GPS chipset 30 and/or the computing environment 8 and/or the handheld installer device 10. The location determination unit 126 may receive and/or determine one or more signal quality indicators 124 and select at least a primary or preferred cellular service provider to be used by the cellular radio 16 to receive and transmit premises monitoring services related communications.

The location determination unit 126 may be configured to sort an ordered list of the locations based at least in part on the associated table of signal quality indications 124. Thus, the cellular service provider identities corresponding to a plurality of cellular service providers, the locations and the signal quality indicators 124 may be implemented as associated tables of a datastore. In some embodiments, an ordered list of cellular service providers included in the cellular service provider information 116 and signal quality indicators 124 may be transmitted to the computing environment 8 and/or the handheld installer device 10 to be stored in the respective one of the lookup tables 42, 46. Then, the respective location unit 38, 44 may determine which cellular service provider(s) are to be used by the cellular radio 16 based at least in part on the mappings provided by the respective lookup table 42, 46.

In some embodiments, the location determination unit 126 may be implemented by the location unit 38 and may be configured to receive an ordered list of cellular service providers, obtained from cellular service provider information 116, from each of a plurality of premises monitoring systems 4 at different locations stored in locations store 118. The received ordered list may be stored in the lookup table 42. The different locations stored in the lookup table 42 may be distributed over a wide geographical area served by multiple cellular radio base stations 6 and by different cellular service providers. For each premises monitoring system 4, a signal quality indicator 124 may be included in the list for each cellular service provider in the list. This enables the location unit 38 to determine a mapping between locations and cellular service providers over a geographical area of any size according to signal qualities measured at each of a plurality of locations for each subscribed cellular service provider of the premises monitoring system 4. The processing circuitry 92 of the computing environment 8 may be configured to order or reorder a list of cellular service providers and/or locations based at least in part on the signal quality indicators 124. The processing circuitry 92 may be configured to transmit an ordered list of cellular service providers to the premises monitoring system 4.

Similarly, the location determination unit 126 may be implemented by the location unit 44 of the handheld installer device 10 and may be configured to receive an ordered list of cellular service providers in the cellular service provider information 116 of the cellular radio 16 at a premises 5. The ordered list of cellular service providers may be received or determined by the processing circuitry 106 of the handheld installer device 10 and may be stored in the lookup table 46. The processing circuitry 106 may be configured to order or reorder a list of cellular service providers for the location of the premises 5. This ordered list of cellular service providers may be transmitted by the communications interface 104 of the handheld installer device 10 to the cellular radio 16 at the premises 5 and/or to the computing environment 8.

The processing circuitry 50, 58, 80, 92 and/or 106 described above may be configured as one or more central processing units, data buses, buffers, and interfaces to facilitate operation. In addition to or instead of a processor 54, 72, 84, 96, 110 and memory 52, 70, 82, 94, 108, the processing circuitry 50, 58, 80, 92, 106 may comprise other types of integrated circuitry that perform various functionality. Integrated circuitry may include one or more processors, processor cores, field programmable gate arrays (FPGAs), application specific integrated circuits (ASICs), graphics processing units (GPUs), Systems on Chips (SoCs), or other components configured to execute instructions. A processor 54, 72, 84, 96, 110 of the processing circuitry 50, 58, 80, 92, 106 may be configured to access (e.g., write to and/or read from) respective memory 52, 70, 82, 94, 108, which may comprise any kind of volatile and/or nonvolatile memory, e.g., cache, buffer memory, random access memory (RAM), read-only memory (ROM), optical memory, and/or erasable programmable read-only memory (EPROM). Further, memory 52, 70, 82, 94, 108 may be embodied in the form of one or more storage devices. The processing circuitry 50, 58, 80, 92, 106 may be configured to perform various functionality described herein. For example, computer instructions may be stored in memory 52, 70, 82, 94, 108 and/or another computer-readable medium that, when executed by a respective processor 54, 72, 84, 96, 110, causes the processor 54, 72, 84, 96, 110 to perform various functionality described herein.

A memory 52, 70, 82, 94, 108 may store software (which may include one or more software applications) and may include internal or external memory (e.g., database, storage array, network storage devices, etc.) accessible by a respective processor 54, 72, 84, 96, 110 via an internal and/or external connection. The software may include any software or program that configures a processor 54, 72, 84, 96, 110 to perform the steps or processes, as described herein. In particular, the software may include agent portal 40.

The processing circuitry 50, 58, 80, 92, 106 may be configured to control any of the methods and/or processes described herein and/or to cause such methods, and/or processes to be performed, e.g., by cellular radio 16, computing environment 8 and/or handheld installer device 10. Processor 54, 72, 84, 96, 110 corresponds to one or more processors for performing any one or more of the functions described herein with respect to the cellular radio 16, the computing environment 8 and/or the handheld installer device 10. The memory 52, 70, 82, 94, 108 is configured to store data and/or files and/or other information/data. In some embodiments, the software stored in memory 52, 70, 82, 94, 108 may include instructions that, when executed by the processor 54, 72, 84, 96, 110 and/or processing circuitry 50, 58, 80, 92, 106, causes the processor 54, 72, 84, 96, 110 and/or processing circuitry 50, 58, 80, 92, 106 to perform the processes disclosed herein with respect to the cellular radio 16, computing environment 8 and/or the handheld installer device 10. Accordingly, by having computer instructions stored in memory 52, 70, 82, 94, 108 accessible to the processor 54, 72, 84, 96, 110, the processor 54, 72, 84, 96, 110 may be configured to perform the actions described herein.

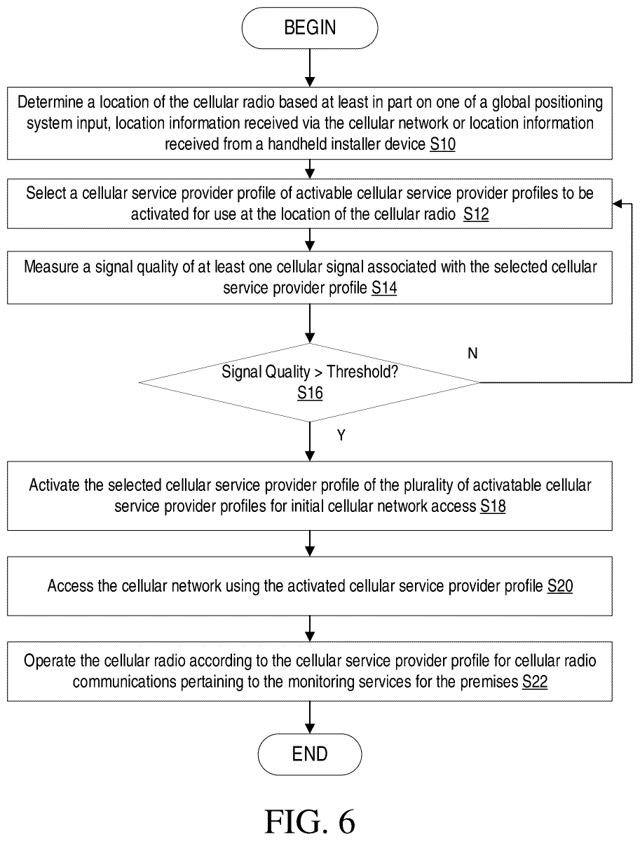

FIG. 6 is a flowchart of an example process performed in a premises monitoring system 4 that includes the cellular radio 16, including the cellular chipset 24, multi-MNO eSIM 26, processor chipset 28 and the GPS chipset 30. The process includes determining a location of the cellular radio 16 based at least in part on one of a global positioning system input, location information received via the cellular network or location information received from a handheld installer device (Block S10). The process further includes selecting a first cellular service provider profile of activable cellular service provider profiles to be activated for use at the location of the cellular radio 16 (Block S12). This may be based at least in part on the determined location and a signal quality indicator associated with the selected cellular service provider profile to be activated. The process includes measuring a signal quality of at least one cellular signal associated with the selected first cellular service provider profile (Block S14). When the signal quality is not greater than a threshold (Block S16), the process returns to Block S12. When the signal quality is greater than the threshold (Block S16), then the process also includes activating the selected first cellular service provider profile of the plurality of activatable cellular service provider profiles for initial cellular network access (Block S18). The process further includes accessing the cellular network using the activated first cellular service provider profile (Block S20). The process also includes operating the cellular radio 16 according to the first cellular service provider profile for cellular radio communications pertaining to the monitoring services for the premises (S22).

In some embodiments, selecting the first cellular service provider profile 64, 66 includes selecting a cellular service provider from an ordered list of cellular service providers, an order of the ordered list being based at least in part on the signal quality indicator associated with each cellular service provider in the ordered list. In some embodiments, the ordered list of cellular service providers are stored in at least one of a lookup table 42, 46, 76 in a database. In some embodiments, the instructions are further configured to cause the at least one processor 54, 72 to determine a signal quality indicator for at least one activatable cellular service provider profile 64, 66 based at least in part on signal measurements. In some embodiments, the instructions are further configured to cause the at least one processor 54, 72 to determine a signal quality indicator for each activatable cellular service provider profile 64, 66 from a lookup table 42, 46, 76 in a database.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module and/or unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in any computer programming language including object oriented programming language such as Python, Java® or C++. The computer program code for carrying out operations of the disclosure may also be written in any computer programming language including conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

In addition, unless mention was made above to the contrary, the accompanying drawings are not to scale. A variety of modifications and variations are possible considering the above teachings without departing from the scope of the present disclosure.

What is claimed is:

1. A premises monitoring system configured to provide monitoring services for a premises, the premises monitoring system comprising:
a cellular radio, comprising:
a cellular radio chipset;
a multi-cellular service provider embedded subscriber identity module (eSIM) configured to store a plurality of cellular service provider profiles that are each activatable for communicating with a cellular network; and
at least one processor; and
at least one memory storing instructions that, when executed by the at least one processor, cause the at least one processor to:
determine a location of the cellular radio based at least in part on one of a global positioning system input, location information received via the cellular network or location information received from a handheld installer device;
select a first cellular service provider profile of activable cellular service provider profiles to be activated for use at the location of the cellular radio based at least in part on the determined location and a signal quality indicator associated with the selected cellular service provider profile to be activated;
measure a signal quality of at least one cellular signal associated with the selected first cellular service provider profile;
activate the selected first cellular service provider profile of the plurality of activatable cellular service provider profiles for initial cellular network access;
access the cellular network using the activated first cellular service provider profile; and
operate the cellular radio according to the first cellular service provider profile for cellular radio communications pertaining to the monitoring services for the premises.

2. The premises monitoring system of claim 1, wherein the instructions are further configured to cause the at least one processor to select the first cellular service provider profile by at least selecting a cellular service provider from an ordered list of cellular service providers, the order of the ordered list being based at least in part on the signal quality indicator associated with each cellular service provider in the ordered list.

3. The premises monitoring system of claim 2, wherein the ordered list of cellular service providers is stored in at least one of a lookup table or a database.

4. The premises monitoring system of claim 1, wherein the instructions are further configured to cause the at least one processor to determine a signal quality indicator for at least one activatable cellular service provider profile based at least in part on signal measurements.

5. The premises monitoring system of claim 1, wherein the instructions are further configured to cause the at least one processor to determine a signal quality indicator for each activatable cellular service provider profile from at least one of a lookup table or a database.

6. A premises monitoring system configured to provide premises monitoring services, the premises monitoring system comprising:
a cellular radio, comprising:
a cellular radio chipset;
a multi-cellular service provider embedded subscriber identity module (eSIM) configured to store a plurality of cellular service provider profiles associated with a plurality of cellular service providers;
at least one processor; and
at least one memory storing instructions that, when executed by the at least one processor, cause the at least one processor to:
determine a location of the cellular radio;
select a first cellular service provider profile from the plurality of cellular service provider profiles based at least in part on the location of the cellular radio;
determine that a signal quality associated with the first cellular service provider exceeds a signal quality threshold; and
in response to determining that the signal quality associated with the first cellular service provider exceeds the signal quality threshold, activate the first cellular service provider profile for cellular radio communications pertaining to the premises monitoring services.

7. The premises monitoring system of claim 6, wherein the instructions are further configured to cause the at least one processor to select the first cellular service provider profile by at least selecting a cellular service provider from an ordered list of cellular service providers, an order of the ordered list being based at least in part on a signal quality indicator associated with each cellular service provider in the ordered list.

8. The premises monitoring system of claim 7, wherein the ordered list of cellular service providers is stored in at least one of a lookup table or a database.

9. The premises monitoring system of claim 6, wherein the instructions are further configured to cause the at least one processor to determine a signal quality indicator for at least one cellular service provider corresponding to a cellular service provider profile based at least in part on signal measurements.

10. The premises monitoring system of claim 6, wherein the instructions are further configured to cause the at least one processor to determine a signal quality indicator for each of at least one cellular service provider indicated in at least one of a lookup table or a database.

11. The premises monitoring system of claim 6, wherein the instructions are further configured to cause the at least one processor to receive data representing the location from a mobile device or a cellular radio base station.

12. The premises monitoring system of claim 6, wherein the instructions are further configured to cause the at least one processor to determine the location using a global positioning system chipset of the cellular radio.

13. The premises monitoring system of claim 6, wherein cellular radio is compliant with at least one of Long Term Evolution (LTE) or Fifth Generation (5G) cellular communication standards.

14. The premises monitoring system of claim 6, wherein each cellular service provider profile stored in the multi-cellular service provider eSIM includes subscriber authorization data and data associated with at least one cellular service provider plan subscribed to by the premises monitoring services provider.

15. The premises monitoring system of claim 6, further comprising a wireless local area network (WLAN) radio configured to communicate with a mobile device to enable configuration of the cellular radio via the mobile device.

16. The premises monitoring system of claim 6, wherein determining a location of the cellular radio is based at least in part on one of a global positioning system input, location information received via a cellular network or location information received from a handheld installer device.

17. A method in a premises monitoring system configured to provide premises monitoring services via at least one of a plurality of cellular service providers that provides cellular radio communication services, the method comprising:
determining a location of a premises based at least in part on one of a global positioning system input, location information received via a cellular radio base station and location information received from a handheld installer device;
selecting for access to a cellular network via a cellular radio, a first cellular service provider profile from a plurality of cellular service provider profiles stored in a multi-cellular service provider embedded subscriber identity module (eSIM) based at least in part on a signal quality indicator associated with the selected first cellular service provider profile and the location of the premises; and
accessing cellular radio communications via a first cellular service provider corresponding to the selected first cellular service provider profile and operating the cellular radio to transmit and receive cellular radio communications pertaining to the premises monitoring services via the first cellular service provider.

18. The method of claim 17, wherein selecting the first cellular service provider includes selecting a cellular service provider from an ordered list of cellular service providers, an order of the ordered list being based at least in part on the signal quality indicator associated with each cellular service provider in the ordered list.

19. The method of claim 17, further comprising determining a signal quality indicator associated with each of at least one cellular service provider based at least in part on measurements of signals from the at least one cellular service provider.

20. The method of claim 17, wherein each cellular service provider profile stored in the multi-cellular service provider eSIM includes subscriber authorization data and data associated with at least one cellular service provider plan subscribed to by a premises monitoring services provider.
